(19) United States
(12) Patent Application Publication
(10) Pub. No.: US 2004/0086670 A1
(43) Pub. Date: May 6, 2004

(54) Electromagnetic shielding by water-borne film

(76) Inventors: Jae H. Choi, Adams, CO (US); David A. Norte, Adams, CO (US); Woong K. Yoon, Adams, CO (US)

Correspondence Address: Docket Administrator, Avaya Inc., (Room 1N-391), 307 Middletown-Lincroft Road, Lincroft, NJ, 07738, US

(21) Appl. No.: 10/283,534

(22) Filed: Oct. 30, 2002

(51) Int. Cl. B32B 1/02; B05D 1/18

(52) U.S. Cl. 428/35.7; 427/430.1

(57) ABSTRACT

An electromagnetically-shielded enclosure is formed by applying an electromagnetic-shielding film to a plastics enclosure by the water-borne film application process. The film is formed from a mixture comprising a polymer and a conductive material, such as lossy ferrite, carbon glass, or metal, that constitutes 20 to 40 percent by weight of the mixture.

### TECHNICAL FIELD

This invention relates to electromagnetic shielding in general and to electronics enclosures that provide electromagnetic shielding in particular.

### BACKGROUND OF THE INVENTION

Electronic products often use a plastics enclosure (e.g., a “housing” or a “cabinet”), usually because of plastic's low cost, light weight, and ability to be easily moulded into complex shapes. These characteristics give plastics enclosures advantage over metal ones. However, unlike metal enclosures, plastics enclosures do not provide shielding against electromagnetic radiation from the enclosed electronics.

In order to comply with electromagnetic compatibility (EMC) regulations, plastics enclosures are usually coated with conductive paint. The coating process usually requires the application of several coats of paint in order to achieve a uniform coating and avoid “spottiness” (voids in the coating through which electromagnetic energy can leak). Nevertheless, uniformity is difficult to achieve, especially if the paint is being applied by hand (e.g., being sprayed on).

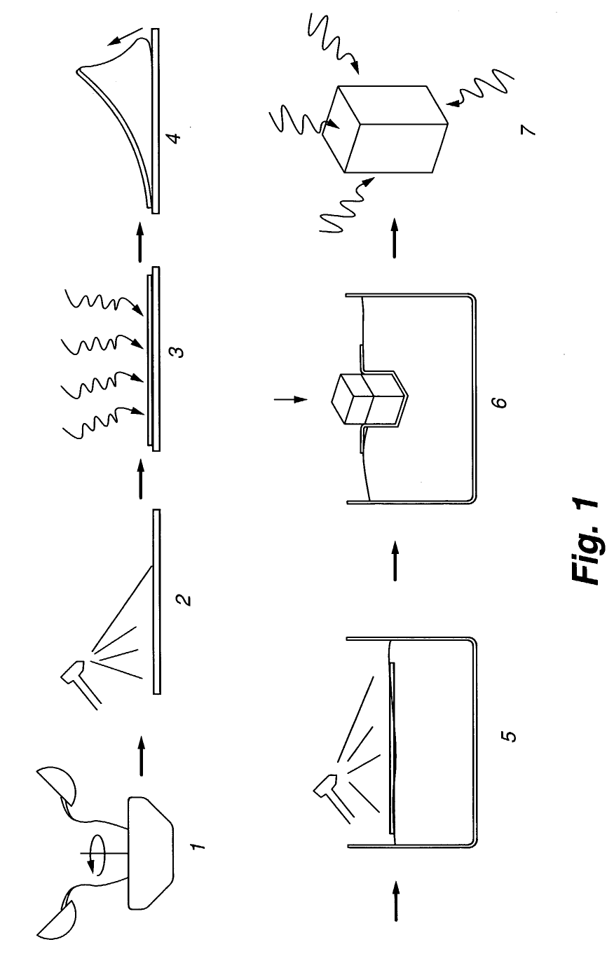

The recently-introduced water-borne film application technology is used to apply decorative images to objects. The process is illustrated in FIG. 1. It starts with mixing ingredients, at step 1, to form a coating mixture comprising a binder suspended in a volatile solvent. This may be an aqueous-coating, water-thinned, water-reducible, emulsion, latex, casein, cement, or silicate paint. The binder is usually a polymer such as a low molecular-weight resin or acrylics. The binder can exist in solution or dispersion form. The volatile solvent is either water or water mixed with a miscible co-solvent such as a glycolether or diethyleneglycolmonoethylether. A layer of the coating mixture is applied to a support surface such as a release paper or a Teflon-coated panel by spray or stencil to form a film of the desired image or design, at step 2, and allowed to dry into a film, at step 3. The film is then lifted from the support surface, at step 4. The film is then suspended on top of a water bath and coated with a solvent which activates and dissolves the film into a viscous jelly-like form, at step 5. This form is a colloid in which the disperse phase has combined with the continuous phase to produce a semi-solid material. The object to be decorated is then dipped, immersed, into the water bath through the disperse phase of the coating film, at step 6, thus transferring the film—and the design or image that it carries—to the surface of the object. The object is then removed from the bath and the film is allowed to dry thereon, at step 7.

### SUMMARY OF THE INVENTION

The invention is directed to an electromagnetic-shielding coating that is adapted to be applied to electronics enclosures by the water-borne film application process. It is also directed to using the waterborne film application process to apply an electromagnetic-shielding coating to electronics enclosures. Generally according to one aspect of the invention, an electrically conductive material, such as a lossy ferrite, carbon glass, or metal such as gold or aluminum, is combined with a polymer to form a binder that is suspendable in a solvent to form a coating mixture for producing a water-borne film. A film of a desired thickness is produced from the coating mixture and is applied to an electronics enclosure via the water-borne film application process to form an electronics enclosure that provides shielding against electromagnetic radiation. According to another aspect of the invention, the water-borne film application process is used to apply a film containing a binder formed from a polymer combined with an electrically conductive material to an electronics enclosure to form an electronics enclosure that provides shielding against electromagnetic radiation. According to another aspect of the invention, an electronics enclosure that provides shielding against electromagnetic radiation comprises a coating of a film of polymer combined with an electrically-conductive material that is applied to the enclosure by the water-borne film application process.

Where the invention has been characterized in terms of method, it also encompasses apparatus that performs the method. The apparatus preferably includes an effector—any entity that effects the corresponding step, unlike a means—for each step.

As used herein the term “enclosure” refers to the enclosure as a whole as well as to any component thereof (e.g., a “panel” or a “door”).

### BRIEF DESCRIPTION OF THE DRAWING

These and other features and advantages of the invention will become more apparent from the following description of an illustrative embodiment of the invention considered together with the drawing, wherein:

The FIGURE is a pictograph of the water-borne film application process.

### DETAILED DESCRIPTION

The inventors have adapted the water-borne film application technology to coating of articles with electromagnetic insulation. They have designed water-borne film formulations that provide the requisite electromagnetic insulation properties. Suitable water-borne formulations are defined in Table A.

TABLE A

| | Range | Example Formulation |
|---|---|---|
| Ingredient | (percent by weight) | (percent by weight) |
| water | 5-20 | 10 |
| conductor | 20-40 | 30 |
| pigment dispersant | .05-.2 | .1 |
| resin | 19-21 | 19.7 |
| amine solubilizer | .7-1.2 | 1.0 |
| flow additive | .2-.5 | .4 |
| drier | .1-.3 | .2 |
| co-solvent | 7-13 | 9.7 |
| defoamer | .05-.2 | .1 |

The conductor is preferably a ferrite powder. The class of ferrite materials that are candidates for use as the conductor are “lossy” ferrites, where “lossy” refers to the electromagnetic-energy-absorptive capability of the material. The ferrite powder is crystalline, having a spinel structure and consisting of ferric oxide and one other metal. Manganese-zinc-based ferrite from Phillips Company of Germany, or nickel-zinc-based ferrite from Steward Company of Chattanooga, Tenn., are examples of suitable materials. Carbon glass powder can also be used. The class of carbon glass materials that are candidates for use as the conductor are those that exhibit high electrical conductivity and very low volume resistivity (ohms/cm³). Illustrative materials are carbon black and nickel-coated or nickel/copper-coated glass. Oil-based conductive paint may be used but is not preferred. Illustrative conductive paints include gold-based and aluminum-based paints.

The pigment dispersant eliminates the settling of pigments in the mixture. Anionic surfactant (a surface-reactive agent) is preferably used. Examples of suitable materials are Vasperse 1 from Vatan Kimya Company or Tamol 731 from Rohm & Haas Company.

The resin is the principal film-former and film-binder. The binder is an organic polymer, such as a poly(vinyl acetate), poly(methacrylic acid), poly(methyl acrylate), poly(methyl methacylate) poly(ethyl-hexyl acrylate), and poly(methacrylic acid). These polymers are commonly called “acrylics”. One or more of these polymers may be used alone or in combination.

The amine solubilizer helps in solubilizing the binder. It is preferably a highly-efficient co-dispersant that improves the stability of the viscosity, such as amino-alcohol 2-methyl-propanol (AMP) from Angus Chemical Company.

The flow additive improves film formation, flow, gloss, and deaeration. It also prevents the flooding of pigments. Suitable examples are a solution of alkylammonium salt of a functional polymer in butyl glycol, or Carbam 40 from AAA Company.

The drier is a metal soap, such as V. Dry. CO from Vitan Kimya Company.

The co-solvent helps to solubilize the polymer, adjust the drying rate, improve the leveling and flow, control blistering during baking, and helps in pigment dispersion. One suitable example is glycolether.

The deafoamer is preferably a mineral oil/silica derivative, such as Colloid 600 from Colloids Inc.

To form the film, the ferrite is ground with the dispersant and a portion of the vehicle such as the co-solvent. Only enough vehicle is used to produce a heavy consistency in order to get good shear in the grinding process. After grinding, the remaining materials are added. The mixture is then applied by spray or stencil onto a release paper or a Teflon-coated panel in a thickness that is determined by the desired amount (dB) of attenuation of the electromagnetic radiation.

When the film dries, it is suspended on top of a water bath, and is then coated with a solvent. The solvent activates and dissolves the film into a viscous jelly-like form, turning the film into a colloid in which the disperse phase has combined with the continuous phase to produce a semi-solid material. Suitable solvent formulations are defined in Table B.

TABLE B

| | Range | Example |
|---|---|---|
| | (percent | Formulation |
| Ingredient | by weight) | (percent by weight) |
| water | 92.5-85.4 | 88.9 |
| diethyleneglycolmonobutylether | 0.1-0.4 | .2 |
| ethyleneglycolmonobutylether | 6-9 | 7.9 |
| 1-methylpyrrolidone | 0.5-2.0 | 1.3 |
| ammonium water | 0.1-1.0 | .5 |
| ester alcohol | 0.8-2.2 | 1.2 |

The article to be coated is then dipped, immersed, in the water bath through the dispersed phase of the conductive coating film. The coating is thereby effectively transferred to the surface of the article, where it forms the requisite electromagnetic shield.

Of course, various changes and modifications to the illustrative embodiment described above will be apparent to those skilled in the art. These changes and modifications can be made without departing from the spirit and the scope of the invention and without diminishing the attendant advantages. It is therefore intended that such changes and modifications be covered by the following claims except insofar as limited by the prior art.

What is claimed is:

1. A method of making an electromagnetically-shielded enclosure, comprising:
applying an electromagnetic-shielding film to an enclosure by a water-borne film application process.

2. The method of claim 1 wherein:
applying comprises
suspending a conductive film on a water bath; and
coating the enclosure with the film by dipping the enclosure in the bath through the suspended film.

3. The method of claim 2 further comprising:
forming the conductive film by combining a conductive material with a polymer.

4. The method of claim 3 wherein:
the conductive material comprises a lossy ferrite, a carbon glass, or a metal.

5. The method of claim 4 wherein:
the conductive material constitutes substantially between 20 and 40 percent by weight of a film-forming mixture that includes the conductive material and polymer.

6. The method of claim 3 wherein:
forming comprises
forming a coating mixture by combining the conductive material, resin, water, pigment dispersant, amine solubilizer, flow additive, drier, co-solvent, and defoamer,
applying a layer of the coating mixture to a support surface, and
drying the layer to form the film; wherein
suspending includes treating the film with a solvent.

7. The method of claim 6 wherein:
the conductive material constitutes substantially between 20 and 40 percent by weight of the mixture.

8. An electromagnetic-shielding coating comprising:
an electromagnetic-shielding material adapted to form a film for application to an enclosure by a water-borne film application process.

9. The coating of claim 8 wherein:
the material comprises a conductive material combined with a polymer.

10. The coating of claim 9 wherein:
the conductive material comprises a lossy ferrite, a carbon glass, or a metal.

11. The coating of claim 10 wherein:
the conductive material constitutes substantially between 20 and 40 percent by weight of a film-forming mixture that includes the conductive material and polymer.

12. The coating of claim 9 wherein:
the electromagnetic-shielding film is formed from a mixture of the conductive material, resin, water, pigment dispersant, amine solubilizer, flow additive, drier, co-solvent, and defoamer.

13. The coating of claim 12 wherein:
the conductive material constitutes substantially between 20 and 40 percent by weight of the mixture.

14. An electromagnetically-shielded enclosure comprising:
a plastics enclosure; and
an electromagnetic-shielding film applied to the enclosure by a water-borne film application process.

15. The enclosure of claim 14 wherein:
the film comprises a conductive material combined with a polymer.

16. The enclosure of claim 15 wherein:
the conductive material comprises a lossy ferrite, a carbon glass, or a metal.

17. The enclosure of claim 16 wherein:
the conductive material constitutes substantially between 20 and 40 percent by weight of a film-forming mixture that includes the conductive material and polymer.

18. The enclosure of claim 15, wherein:
the electromagnetic-shielding film is formed from a mixture of the conductive material, resin, water, pigment dispersant, amine solubilizer, flow additive, drier, co-solvent, and defoamer.

19. The enclosure of claim 18 wherein:
the conductive material constitutes substantially between 20 and 40 percent by weight of the mixture.
